(19) United States
(12) Patent Application Publication
(10) Pub. No.: US 2026/0370371 A1
(43) Pub. Date: Nov. 19, 2026

(54) Dynamic Channel State Information Manipulation for Physical Layer Security in Private Wireless Networks

(71) Applicant: Dell Products L.P., Round Rock, TX (US)

(72) Inventors: Yasser AlEryani, Kanata (CA); Mostafa Mouawad, New Cairo (EG)

(21) Appl. No.: 19/208,975

(22) Filed: May 15, 2025

(51) Int. Cl. H04K 1/10; H04B 7/06; H04K 1/00; H04K 1/08; H04L 9/40; H04L 25/02

(52) U.S. Cl. CPC H04K 1/10; H04K 1/006; H04K 1/08; H04L 25/0202; H04L 63/0428; H04B 7/0626

(57) ABSTRACT

A system can conduct first broadband cellular communications with a device via a private wireless network, wherein the device satisfies a legitimate receiver criterion associated with classifying receivers as a legitimate receiver. The system can determine channel state information for the first broadband cellular communications. The system can determine perturbations for second broadband cellular communications based on the channel state information, wherein the perturbations modify the channel state information. The system can conduct the second broadband cellular communications with the device based on the perturbations, the device being configured to inversely apply the perturbations to the second broadband cellular communications based on a synchronization protocol between the device and the system, wherein the synchronization protocol is conveyed to the device independently of the first broadband cellular communications and independently of the second broadband cellular communications.

### BACKGROUND

A private wireless network (PWN) can comprise a type of a broadband cellular network that can be viewed in contrast to a public cellular network, where user equipment (UE, or “devices”) can generally access a public cellular network where the UE owner has registered the device and paid for cellular service with the public cellular network's provider. A PWN can generally meet security standards for communications via the network.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can conduct first broadband cellular communications with a device via a private wireless network, wherein the device satisfies a legitimate receiver criterion associated with classifying receivers as a legitimate receiver. The system can determine channel state information for the first broadband cellular communications. The system can determine perturbations for second broadband cellular communications based on the channel state information, wherein the perturbations modify the channel state information. The system can conduct the second broadband cellular communications with the device based on the perturbations, the device being configured to inversely apply the perturbations to the second broadband cellular communications based on a synchronization protocol between the device and the system, wherein the synchronization protocol is conveyed to the device independently of the first broadband cellular communications and independently of the second broadband cellular communications.

An example method can comprise determining, by a system comprising at least one processor, channel state information for first broadband cellular communications that are conducted with a device via a private wireless network. The method can further comprise determining, by the system, perturbations for second broadband cellular communications based on the channel state information, wherein the perturbations modify the channel state information. The method can further comprise conducting, by the system, the second broadband cellular communications with the device based on the perturbations, the device being configured to inversely apply the perturbations to the second broadband cellular communications based on a synchronization protocol used for synchronization between the device and the system, wherein the synchronization protocol is conveyed to the device independently of the first broadband cellular communications and independently of the second broadband cellular communications.

An example non-transitory computer-readable medium can comprise instructions that, in response to execution, cause a system comprising a processor to perform operations. These operations can comprise determining channel state information for first broadband cellular communications that are conducted with a device via a private wireless network. These operations can further comprise determining perturbations for second broadband cellular communications based on the channel state information, wherein the perturbations modify the channel state information. These operations can further comprise conducting the second broadband cellular communications with the device based on the perturbations, the device being configured to inversely apply the perturbations to the second broadband cellular communications based on a synchronization capability usable to synchronize information between the device and the system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate dynamic channel state information manipulation for physical layer security in private wireless networks, in accordance with an embodiment of this disclosure;

FIG. 2 illustrates an example of a legitimate receiver that can facilitate dynamic channel state information manipulation for physical layer security in private wireless networks, in accordance with an embodiment of this disclosure;

FIG. 3 illustrates an example of an eavesdropper that can facilitate dynamic channel state information manipulation for physical layer security in private wireless networks, in accordance with an embodiment of this disclosure;

FIG. 4 illustrates another example of a legitimate receiver that can facilitate dynamic channel state information manipulation for physical layer security in private wireless networks, in accordance with an embodiment of this disclosure;

FIG. 5 illustrates another example of an eavesdropper that can facilitate dynamic channel state information manipulation for physical layer security in private wireless networks, in accordance with an embodiment of this disclosure;

FIG. 6 illustrates an example of waveforms of an original signal and a perturbed signal, and that can facilitate dynamic channel state information manipulation for physical layer security in private wireless networks, in accordance with an embodiment of this disclosure;

FIG. 7 illustrates an example of waveforms of an original signal, a signal at a legitimate receiver after compensation, and a signal at an eavesdropper, and that can facilitate dynamic channel state information manipulation for physical layer security in private wireless networks, in accordance with an embodiment of this disclosure;

FIG. 8 illustrates another example process flow that can facilitate dynamic channel state information manipulation for physical layer security in private wireless networks, in accordance with an embodiment of this disclosure;

FIG. 9 illustrates another example process flow that can facilitate dynamic channel state information manipulation for physical layer security in private wireless networks, in accordance with an embodiment of this disclosure;

FIG. 10 illustrates another example process flow that can facilitate dynamic channel state information manipulation for physical layer security in private wireless networks, in accordance with an embodiment of this disclosure; and

FIG. 11 illustrates an example block diagram of a computer operable to execute an embodiment of this disclosure.

### DETAILED DESCRIPTION

### Overview

In private wireless networks (PWNs), ensuring robust security can be critical due to the sensitive nature of the data that can be transmitted and the potential exposure to both external and internal threats. It can be that traditional encryption techniques at higher protocol layers (relative to the physical layer) can not suffice, especially against sophisticated eavesdropping attacks exploiting the physical layer vulnerabilities. The present techniques provide approaches to enhance physical layer security in PWNs by dynamically manipulating the channel state information (CSI) using machine learning (ML) model. The present techniques can address PWN-specific issues such as fixed infrastructure susceptibility, maintaining high Quality of Service (QoS), and efficient resource utilization. A transmitter within the PWN can continuously estimate the CSI, characteristic of a specific network topology and wireless environment of PWNs. Leveraging a machine learning model trained on PWN channel conditions, the present techniques can generate optimal (or satisfactory; where a superlative is described herein, it can be appreciated that there can be examples the use a satisfactory but not superlative substitute) perturbation patterns that adjust key transmission parameters—including phase, amplitude, and frequency—in real-time. These controlled adjustments can introduce intentional and adaptive anomalies into the transmitted signal's characteristics, which can be imperceptible to legitimate receivers due to a synchronization mechanism unique to PWNs. The receivers, being part of the private network, can possess pre-shared secrets or algorithms allowing them to inversely apply the perturbations and accurately recover the original signal without degradation in QoS. Conversely, unauthorized receivers or eavesdroppers, lacking knowledge of the perturbation patterns and synchronization context inherent to PWNs, can encounter significant obstacles in signal interception. The adaptive nature of the perturbations, tailored to the PWN's specific channel conditions and infrastructure, can result in a rapidly varying effective channel for the eavesdropper, leading to increased error rates and a reduced likelihood of successful data recovery. The present techniques can be implemented to effectively mitigate PWN-specific security challenges by:
Exploiting fixed topology: Utilizing the known topology and predictable channel characteristics of PWNs to optimize the perturbation patterns.
Enhancing insider threat defense: Introducing physical layer security measures that are effective even against adversaries with network access.
Maintaining QoS: Ensuring that legitimate communications within the PWN remain unaffected, preserving the network's performance standards.
Efficient resource use: Avoiding significant additional power or bandwidth consumption, which can be crucial in PWNs where resources can be limited.

By integrating dynamic CSI manipulation with machine learning tailored for PWNs, the present techniques can provide a robust, adaptive, and efficient approach to enhance physical layer security, directly addressing the unique challenges faced by private wireless networks.

Private Wireless Networks (PWNs) can generally comprise specialized communication systems deployed by organizations to support mission-critical operations with enhanced control over network resources, security, and performance. PWNs, which can be implemented using technologies like Long-Term Evolution (LTE) broadband cellular communications, Fifth Generation (5G) broadband cellular communications, or proprietary protocols, can be widely used in sectors such as industrial automation, healthcare, transportation, and defense. These networks can provide dedicated bandwidth, low latency, and high reliability, which can be essential for applications like real-time monitoring, control systems, and secure data exchange.

Despite their advantages, PWNs can face unique security challenges at the physical layer due to their controlled yet potentially predictable environments. Unlike public networks, PWNs can operate in fixed or semi-fixed topologies with known infrastructure layouts and communication patterns. This predictability can be exploited by adversaries who can perform prior reconnaissance to launch targeted attacks. Additionally, PWNs can be susceptible to insider threats, where malicious actors have physical access to the network infrastructure or devices.

Prior approaches to security mechanisms in PWNs primarily focus on higher-layer encryption and authentication protocols. While these can be effective against certain attacks, these measures can be vulnerable to sophisticated eavesdropping techniques that exploit physical layer characteristics. For instance, an adversary can use advanced signal processing and antenna technologies to intercept communications without being detected.

Prior approaches to physical layer security techniques generally aim to safeguard wireless communications by leveraging the randomness and unpredictability of wireless channels. Methods such as artificial noise generation, cooperative jamming, and beamforming have been proposed. However, these techniques encounter limitations in PWNs due to:
Resource constraints: Artificial noise and jamming can consume additional power and bandwidth, which might not be acceptable in resource limited PWNs.
Infrastructure constraints: Beamforming and cooperative methods can require complex antenna arrays and coordination among multiple network nodes, potentially increasing system complexity and costs.
Fixed topologies: The static nature of PWN environments can reduce channel variability, diminishing the effectiveness of randomness-based security techniques.
Quality of Service (QoS) Requirements: Critical applications running on PWNs can demand stringent QoS, which can be affected by aggressive physical layer security measures.

Therefore, there can be a pressing need for a physical layer security solution tailored to the specific characteristics of PWNs-one that enhances security without imposing significant overhead or disrupting critical communications.

The present techniques can be implemented to enhance physical layer security in Private Wireless Networks (PWNs) by dynamically manipulating the Channel State Information (CSI) in a manner that addresses PWN-specific issues. The present techniques can leverage the unique characteristics of PWNs, such as their fixed infrastructure and predictable channel conditions, to optimize security measures without compromising the network's performance or resource efficiency.

In some examples, features of the present techniques can include:
Dynamic CSI manipulation tailored for PWNs: A transmitter in the PWN can adjust transmission parameters (e.g., phase, amplitude, frequency) based on real-time CSI estimations. Unlike prior approaches, this adjustment can be dynamically optimized for the static or semi-static channel conditions typical in PWNs, enhancing security in environments where channel variability can be low.
Machine learning algorithms trained on PWN data: A machine learning model can be employed to predict optimal perturbation patterns. The model can be trained using datasets that reflect the specific channel characteristics, topologies, and environmental factors of PWNs. This can ensure that the perturbations are effective in confounding eavesdroppers without affecting legitimate communications.
Synchronization mechanisms suited for PWN infrastructure: The synchronization between a transmitter and a legitimate receiver can leverage the controlled environment of PWNs. Pre-shared keys or algorithms established during network setup allow for precise alignment of perturbations, ensuring that legitimate receivers can correctly decode messages without additional overhead.
Resource-efficient security enhancements: Recognizing that PWNs can have strict resource constraints, the present techniques can minimize additional power and bandwidth requirements. By intelligently manipulating existing transmission parameters rather than adding artificial noise or requiring extra transmissions, the present techniques can conserve resources.
Robustness against insider threats: The present techniques can improve resilience against adversaries who can have insider knowledge or access to the network infrastructure, which can be a significant concern in PWNs. The dynamic and adaptive nature of the perturbations can make it difficult for insiders to predict or counteract the security measures without the proper synchronization information.
QoS preservation: The present techniques can be designed to maintain high QoS standards that can be required for mission-critical applications in PWNs. By ensuring that legitimate receivers can seamlessly recover the original signal, the present techniques can avoid introducing delays or errors that could disrupt essential services.

The present techniques can address PWN-specific issues, as follows:
Fixed infrastructure susceptibility: By utilizing machine learning models trained on the specific, and often static, characteristics of the PWN infrastructure, the present techniques can effectively introduce unpredictability into the channel. This can counter the predictability that can be exploited by adversaries in such environments.
Limited channel variability: In PWNs where channel conditions are stable, prior approaches to physical layer security methods that rely on natural channel variations can be less effective. The present techniques can artificially induce controlled variations, enhancing security despite the underlying channel stability.
Insider threats: The synchronization mechanisms can be securely established and difficult for insiders to compromise without detection. Even if an insider gains some knowledge of the network, without access to the dynamic perturbation algorithms and synchronization keys, intercepting communications remains challenging.
Resource constraints: The present techniques can facilitate adjusting existing transmission parameters, rather than introducing additional signals, and this can align with the resource limitations of PWNs. This can ensure that security enhancements do not come at the cost of increased power consumption or reduced network capacity.
QoS requirements: Since the legitimate receiver can inversely apply the known perturbations, the impact on QoS can be minimized. This can be critical for PWNs where reliability and performance can be essential for operations such as industrial control systems or healthcare monitoring.

The following is an operational overview of examples of the present techniques:
Channel estimation: The transmitter can continuously perform channel estimation to obtain up-to-date CSI reflective of the PWN's conditions.
Perturbation generation: Using the estimated CSI and input from the machine learning model, the transmitter can generate perturbation patterns that optimize security while considering the PWN's QoS and resource constraints.
Transmission parameter adjustment: The transmitter can adjust its transmission parameters, accordingly, introducing controlled and dynamic perturbations into the signal.
Synchronization with receiver: The legitimate receiver, being part of the PWN, can use pre-shared synchronization information to apply inverse perturbations, ensuring accurate signal recovery.
Security against eavesdroppers: Eavesdroppers, lacking synchronization information and unable to predict the perturbations, can experience a degraded channel, with the effective CSI appearing random and rapidly changing.

The present techniques can offer the following advantages relative to prior approaches:
Adaptability: The machine learning model can allow a system to adapt to the specific and potentially changing conditions within a PWN, such as varying interference levels or new security threats.
Efficiency: By not requiring additional hardware or excessive resource consumption, the present techniques can be implemented within existing PWN infrastructures with minimal modifications.
Scalability: The present techniques can scale with the size and complexity of the PWN, as the machine learning model can be retrained or updated to accommodate new devices or infrastructure changes.
Compliance with PWN Standards: The method can be compatible with standard PWN protocols and technologies, facilitating integration without violating regulatory requirements or network policies.

The present techniques can facilitate enhancing physical layer security in private wireless networks through dynamic manipulation of Channel State Information (CSI). By incorporating machine learning techniques and real-time channel analysis, the present techniques can provide a robust, adaptive security solution tailored to the specific challenges of private wireless networks (PWNs). Example aspects of the present techniques include:

Dynamic manipulation of transmission parameters:
Continuous CSI estimation: The transmitter can perform real-time estimation of the CSI between itself and the legitimate receiver.
Controlled perturbations:
   Phase Shifts: Introducing specific phase alterations to the transmitted signal.
   Amplitude Adjustments: Varying signal amplitude within permissible limits.
   Frequency variations: Modulating the carrier frequency according to predetermined patterns.
Purpose: These perturbations can alter the CSI in a controlled manner, creating an unpredictable channel for unauthorized receivers.

Transparency to legitimate receivers:
Synchronization mechanism:
   Pre-Shared Secrets: Keys or algorithms can be shared during a secure initialization phase.
   Time-Varying Algorithms: Dynamic algorithms can be known only to the transmitter and legitimate receiver.
Inverse perturbation application:
   The legitimate receiver can use synchronization information to apply inverse perturbations.
   Result: Accurate recovery of the original signal without degradation of Quality of Service (QoS).

Confounding potential eavesdroppers:
Lack of synchronization: It can be that eavesdroppers do not possess the perturbation patterns or synchronization keys.
Degraded signal quality:
   Artificial channel variability: The perturbations can cause rapid, unpredictable changes in the channel as perceived by the eavesdropper.
   Increased error rates: Difficulty in decoding the signal due to mismatched transmission parameters.
Enhanced security: Physical Layer Protection: This can add a layer of security that can be independent of higher-layer encryption methods.

Machine learning-driven optimization:
Adaptive perturbation patterns:
   Input: Real-time CSI and predefined security and QoS requirements.
   Output: Optimized perturbation parameters tailored to current network conditions.
Model training:
   Datasets: Trained on a variety of channel conditions specific to PWNs.
   Goals: Maximize secrecy capacity while preserving QoS.
Benefits:
   Adaptability: Adjusts to changing channel conditions and threat landscapes.
   Efficiency: Reduces unnecessary resource consumption by targeting perturbations effectively.

Real-time channel analysis and adaptation:
Environmental awareness: The present techniques can monitor channel conditions continuously, accounting for factors such as interference, mobility, and environmental changes.
Responsive adjustments: Perturbation patterns can be adjusted in real-time to maintain optimal security levels.

Addressing PWN-specific issues:
Fixed infrastructure utilization: This can leverage knowledge of PWN topology and infrastructure to optimize perturbation strategies.
Insider threat mitigation: Synchronization mechanisms can be secured against insider attacks, making unauthorized interception difficult even for users within the network.
Resource efficiency:
   Minimal overhead: The present techniques can avoid significant additional power or bandwidth usage.
   Preserved QoS: This can ensure critical PWN applications remain unaffected by security enhancements.

Robustness against various attack scenarios:
Adaptive defense mechanism: The present techniques can adjust to different types of attacks, including eavesdropping, spoofing, and more sophisticated physical layer threats.
Machine learning evolution: The model can learn from detected threats and historical data to improve future security measures.

Integration with existing PWN infrastructure:
Compatibility: This can be implemented within existing PWNs without significant hardware changes.
Scalability: Suitable for various network sizes and configurations.

Advantages over prior approaches:
Enhanced physical layer security: Provides a security layer that complements traditional encryption methods.
Adaptability and learning: Machine learning can enable a system to evolve alongside emerging threats.
Transparency and efficiency: Legitimate users can experience no noticeable impact, ensuring seamless communication.

In summary, the present techniques can facilitate enhancing physical layer security in private wireless networks by dynamically manipulating CSI through controlled perturbations in transmission parameters. This present techniques can be:
Transparent to legitimate receivers due to synchronization and inverse perturbation application.
Confounding to potential eavesdroppers who lack necessary synchronization information.
Optimized using machine learning algorithms that adapt to real-time channel conditions and security requirements.
Tailored to address specific challenges of PWNs, including fixed infrastructure susceptibility and resource constraints.
Robust against various attack scenarios, providing an adaptive and efficient security solution.

By integrating these elements, the present techniques can effectively enhance the security of private wireless communications without compromising performance or requiring significant additional resources, thereby meeting the critical requirements of modern PWNs.

The present techniques can be implemented to integrate dynamic CSI manipulation with machine learning optimization to enhance physical layer security in private wireless networks. By mathematically formulating the perturbation process and its impact on both legitimate receivers and potential eavesdroppers, the present techniques can provide a robust and efficient approach to secure wireless communications against unauthorized interception. The present techniques can incorporate advanced signal processing techniques, secure synchronization mechanisms, and adaptive machine learning models.

These elements can collectively ensure that the legitimate receiver maintains high QoS while the eavesdropper's ability to decode the signal can be significantly impaired.

### Example Architectures, Etc.

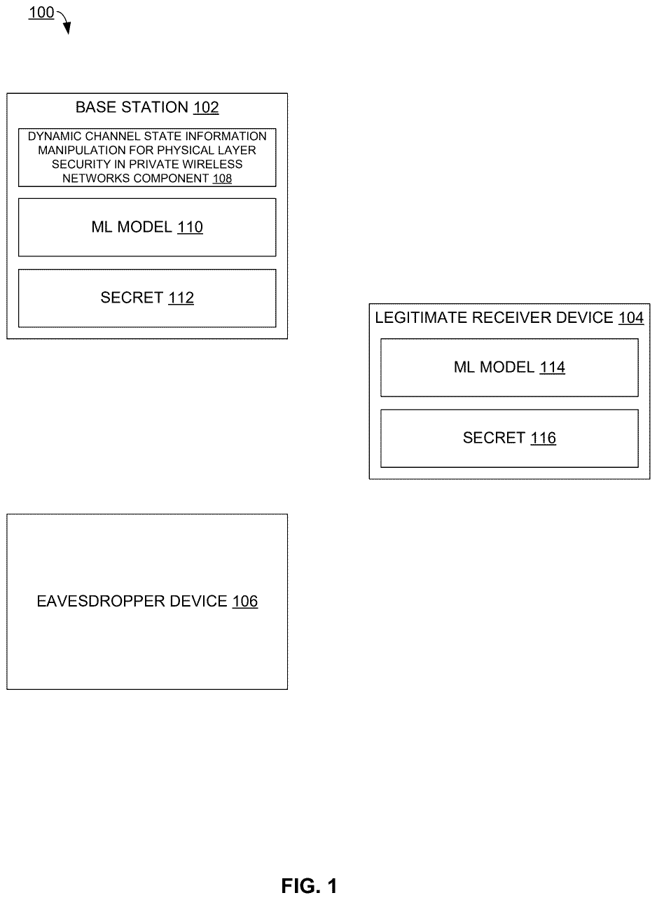

FIG. 1 illustrates an example system architecture 100 that can facilitate dynamic channel state information manipulation for physical layer security in private wireless networks, in accordance with an embodiment of this disclosure.

System architecture 100 comprises base station 102, legitimate receiver device 104, and eavesdropper device 106. In turn, base station 102 comprises dynamic channel state information manipulation for physical layer security in private wireless networks component 108, ML model 110, and secret 112. And legitimate receiver device 104 comprises ML model 114 and secret 116.

Base station 102 can conduct broadband cellular communications with legitimate receiver device 104. To mitigate against eavesdropper device 106 listening in on these communications, base station 102 can both insert perturbations into communications, and modify them over time. Base station 102 can determine the perturbations based on inputting CSI information into ML model 110, and add these perturbations to transmissions.

Legitimate receiver device 104 can use its copy of ML model 114 to determine what the perturbations are and perform an inverse of them on the received signal, to decode the transmitted signal. Where eavesdropper device 106 lacks a copy of the ML model, it can be unable to correctly decode the transmitted signal in a similar manner.

ML model 114 at legitimate receiver device 104 can have the same weights as that of ML model 110 of base station 102, so that ML model 114 can perform a reverse inference as ML model 110, to extract the original CSI (before perturbations were added by base station 102).

Base station 102 and legitimate receiver device 104 can synchronize changing the perturbations over time, and can use secret 112 and secret 116 to do so. Where eavesdropper device 106 lacks a copy of the secret, it can be further unable to correctly decode the transmitted signal in a similar manner.

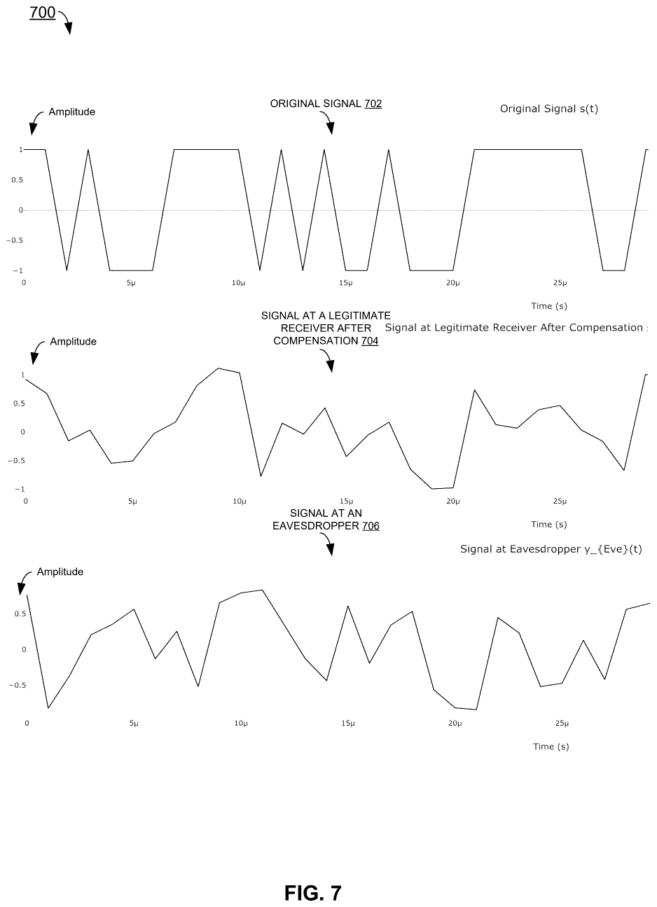

In some examples, dynamic channel state information manipulation for physical layer security in private wireless networks component 108 can implement part(s) of the process flows of FIGS. 7-10 to implement dynamic channel state information manipulation for physical layer security in private wireless networks.

It can be appreciated that system architecture 100 is one example system architecture for dynamic channel state information manipulation for physical layer security in private wireless networks, and that there can be other system architectures that facilitate dynamic channel state information manipulation for physical layer security in private wireless networks.

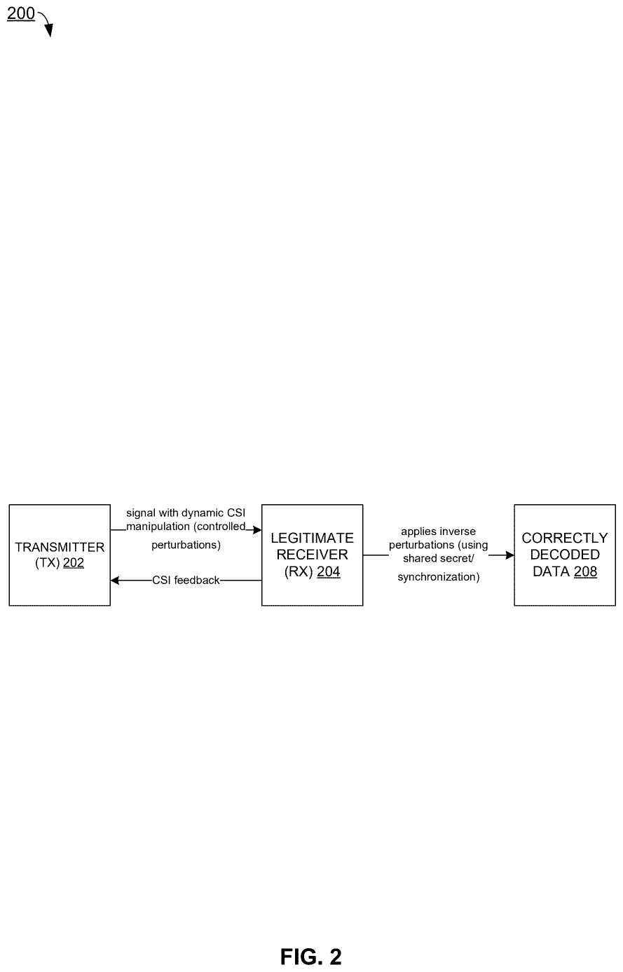

FIG. 2 illustrates an example 200 of a legitimate receiver that can facilitate dynamic channel state information manipulation for physical layer security in private wireless networks, in accordance with an embodiment of this disclosure. In some examples, part(s) of example 200 can be used by part(s) of system architecture 100 of FIG. 1 to facilitate dynamic channel state information manipulation for physical layer security in private wireless networks.

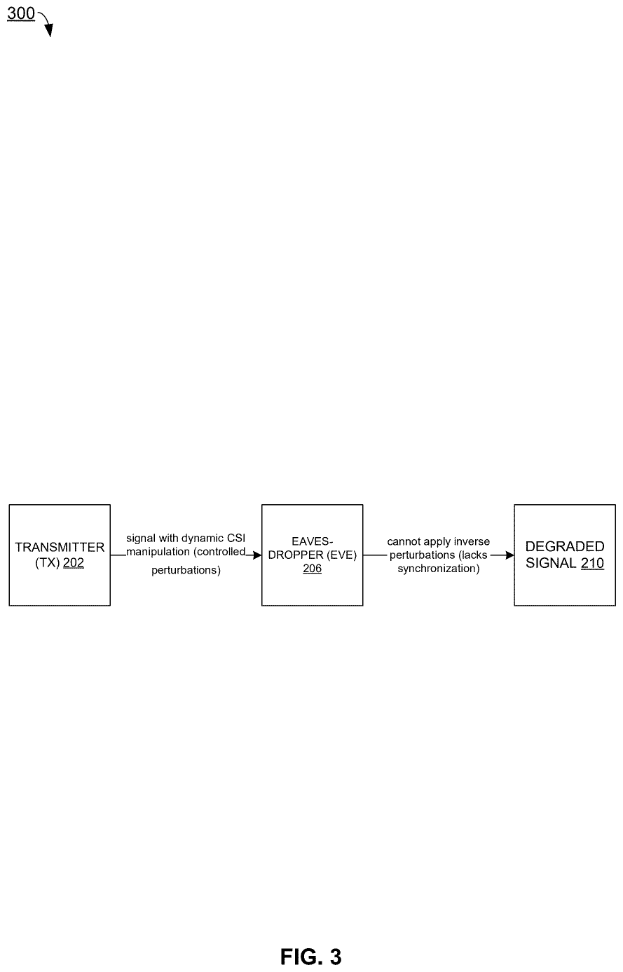

FIG. 3 illustrates an example 300 of an eavesdropper that can facilitate dynamic channel state information manipulation for physical layer security in private wireless networks, in accordance with an embodiment of this disclosure;

Between example 200 and example 300, there are three primary entities:
Transmitter (Tx) 202: Part of the private wireless network (PWN), equipped with capabilities to perform dynamic Channel State Information (CSI) manipulation.
Legitimate Receiver (Rx) 204: Also, part of the PWN, synchronized with the transmitter, and capable of applying inverse perturbations to decode the received signals accurately. Legitimate receiver 204 can end up with correctly decoded data 208.
Eavesdropper (Eve) 206: An unauthorized entity attempting to intercept communications between Tx and Rx without access to synchronization information or perturbation patterns. Eavesdropper 210 can end up with degraded signal 210.

Transmitter 202 and legitimate receiver 204 can communicate over a wireless channel characterized by its CSI. A goal can be to enhance physical layer security by modifying the transmission in such a way that only the legitimate receiver, with knowledge of the perturbation scheme, can decode the transmitted messages.

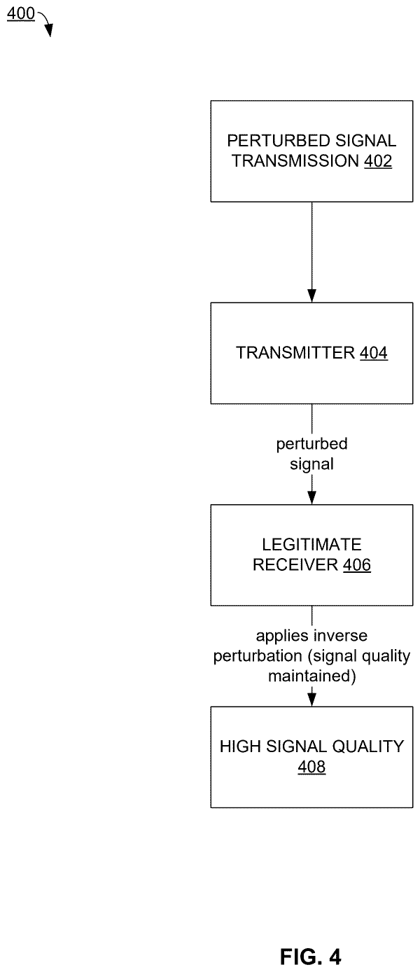

FIG. 4 illustrates another example 400 of a legitimate receiver that can facilitate dynamic channel state information manipulation for physical layer security in private wireless networks, in accordance with an embodiment of this disclosure. In some examples, part(s) of example 400 can be used by part(s) of system architecture 100 of FIG. 1 to facilitate dynamic channel state information manipulation for physical layer security in private wireless networks.

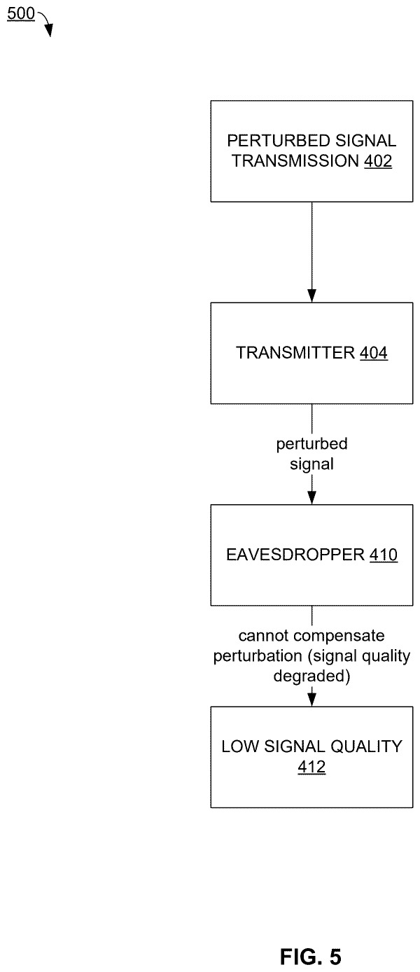

FIG. 5 illustrates another example 500 of an eavesdropper that can facilitate dynamic channel state information manipulation for physical layer security in private wireless networks, in accordance with an embodiment of this disclosure. In some examples, part(s) of example 500 can be used by part(s) of system architecture 100 of FIG. 1 to facilitate dynamic channel state information manipulation for physical layer security in private wireless networks.

Between example 400 and example 500, the following are depicted: perturbed signal transmission 402, transmitter 404, legitimate receiver 406, high signal quality 408, eavesdropper 410, and low signal quality 412.

A dynamic CSI manipulation process according to FIGS. 4 and/or 5 can involve the following steps:

### Channel Estimation:

The transmitter can estimate the CSI h_{T}_{ₓ}_{R}_{ₓ} between itself and the legitimate receiver using pilot signals or other channel estimation techniques.
The estimation can be represented mathematically as:

h_{T}_{ₓ}_{R}_{ₓ}=EstimateChannel(Tₓ,Rₓ)

### Perturbation Pattern Generation:

The transmitter can employ a machine learning model [symbol] to determine the optimal perturbation parameters θ based on the estimated CSI and pre-defined requirements.
The model can consider factors such as maximizing secrecy capacity Cₛ and maintaining Quality of Service (QoS).
The perturbation parameters can be expressed as:

θ= [symbol] (h_{T}_{ₓ}_{R}_{ₓ},S_{req},Q_{req})
where:
S_{req}: denotes the security requirements.
Q_{req}: denotes the QoS requirements.

### Transmission Parameter Adjustment:

The transmitter can adjust the transmission parameters using the perturbation parameters θ.
The baseband transmitted signal s(t) can be modified to s′(t) as follows:

s′(t)=s(t)·A(t)·e^{i(φ(t)+2πf}^{_{offset}}^{(t)t)}
where:
φ(t) is the time-varying phase shift.
A(t) is the amplitude variation.
f_{offset} is the frequency offset.
s(t) is the original modulated signal.

### Signal Transmission:

The perturbed signal s′(t) can be transmitted over the wireless channel.
The signal received by the legitimate receiver is:

y_{R}_{ₓ}(t)=h_{T}_{ₓ}_{R}_{ₓ}·s′(t)+n_{R}_{ₓ}(t)

where n_{R}_{ₓ}(t) can be the additive noise at the receiver.
Synchronization with Legitimate Receiver:
The legitimate receiver, possessing synchronization information (e.g., secret keys, algorithms), can apply inverse perturbations to recover the original signal.
The receiver can compute the inverse perturbation parameters θ⁻¹:

θ⁻¹=ComputInversePerturbation(θ,SyncInfo)·
The compensated received signal is:

$${s}_{comp} ( t ) = {y}_{{R}_{x}} ( t ) \cdot \frac{1}{A ( t )} \cdot {e}^{- i ( ϕ ( t ) + 2 {π f}_{offset} ( t ) t )}$$

The receiver can then demodulate s_{comp}(t) to recover the transmitted data.

Perturbation techniques can be as follows.

The perturbation patterns involve adjustments to transmission parameters, as follows.

### Phase Shifting:

The phase of the signal can be modified using a pseudorandom sequence φ(t) known only to Tx and Rx.
Mathematically:

S_{φ}(t)=s(t)·e^{-iφ(t)}
The pseudorandom sequence can be generated using a secure algorithm seeded with shared secret information.

### Amplitude Variation:

The amplitude can be varied within acceptable limits to avoid excessive distortion.
Mathematically:

S_{A}(t)=A(t)·s(t)
The amplitude variation A(t) can be designed to be invertible by the legitimate receiver.

### Frequency Hopping:

The carrier frequency can be rapidly changed according to a hopping pattern f_{offset}(t).
The transmitted signal becomes:

S_{f}(t)=S(t)·e^{i2πf}^{_{offset}}^{(t)t}
The hopping pattern can be synchronized between Tx and Rx.

A machine learning model for perturbation optimization can be as follows. The machine learning model [symbol] (⋅) can play a role in optimizing the perturbation parameters:

### Model Architecture:

The model can be implemented using a deep neural network (DNN) designed to handle input features related to channel conditions and desired security levels.
Input Features:
   Estimated CSI h_{T}_{ₓ}_{R}_{ₓ}
   Security requirements S_{req}
   QoS requirements Q_{req}
Output: Optimal perturbation parameters θ

### Training Process:

The model can be trained on datasets containing various channel conditions and corresponding optimal perturbations.
The loss function can aim to maximize the secrecy capacity Cₛ while minimizing the impact on QoS.
Secrecy capacity Cₛ can be defined as:

Cₛ=[C_{b}−Cₑ]⁺
where:
C_{b} is the capacity of the main channel (Tx to Rx).
Cₑ is the capacity of the eavesdropper's channel (Tx to Eve).
[x]⁺ denotes max (0, x).

### Optimization Objective:

The model can seek perturbation parameters that maximize Cₛ subject to:
   QoS constraints (e.g., minimum signal-to-noise ratio at Rx).
   Power constraints on transmission.
The optimization problem can be formulated as:

$${max}_{θ} {C}_{s} ( θ )$$

$$subject to$$

$$\{ \begin{matrix}QoS ( θ ) \geq {Q}_{min} \\ P ( θ ) \leq {P}_{max}\end{matrix}$$

where:
Qₘᵢₙ is the minimum acceptable QoS level.
P(θ) is the transmission power consumption as a function of θ.
Pₘₐₓ is the maximum allowable power.

Effect on eavesdropper: The eavesdropper's received signal can be expressed as:

y_{Eve}(t)=h_{TxEve}·S′(t)+n_{Eve}(t)
where:
h_{T}_{ₓ}_{Eve} is the CSI between Tx and Eve.
n_{Eve}(t) is the noise at the eavesdropper's receiver.

Without knowledge of the perturbation parameters θ, it can be that Eve cannot compensate for the modifications in the signal. As a result:

### Signal Mismatch:

The perturbations cause a mismatch in the expected signal structure.
This can lead to symbol errors and degraded bit error rates (BER).

### Reduced Eavesdropper Capacity:

The capacity of Eve's channel Cₑ can be significantly reduced.
The secrecy capacity Cₛ increases, enhancing security.

Mathematically, the eavesdropper's signal can be considered as passing through an effective channel h_{eff}:

h_{eff}=h_{T}_{ₓ}_{Eve}·θ

Since it can be that Eve does not know θ, h_{eff} can appear to be random and rapidly changing, making reliable decoding difficult.

Synchronization with a legitimate receiver can be implemented as follows. To ensure that the legitimate receiver can invert the perturbations:

### Secure Initialization:

During a secure setup phase, Tx and Rx share secret keys or initialize a secure algorithm.
This can involve key exchange protocols or physical layer security approaches like secret key generation from channel reciprocity.

### Synchronization Mechanism:

Time synchronization can ensure that both Tx and Rx apply perturbations and inverse perturbations at the correct times.

### Inverse Perturbation Application:

The legitimate receiver uses the shared information to compute the inverse perturbations θ⁻¹
Mathematically, the recovered signal is:

S_{rec}(t)=y_{R}_{ₓ}(t)·θ⁻¹

### Resulting in Accurate Decoding:

After compensation, the receiver performs standard demodulation and decoding.
The QoS at Rx remains within acceptable levels, ensuring reliable communication. Advantages of implementing the present techniques can be as follows.

### Enhanced Security:

By dynamically manipulating CSI, the secrecy capacity Cₛ can be increased.
The method can be effective even when the eavesdropper has a better channel (e.g., |h_{T}_{ₓ}_{Eve}|>|h_{T}_{ₓ}_{R}_{ₓ}|).

### Adaptability:

The machine learning model allows adaptation to changing channel conditions and evolving attack strategies.
The system can be retrained or updated with new data to improve performance over time.

### Transparency to Legitimate Users:

Synchronization mechanisms ensure that legitimate receivers can compensate for perturbations without significant impact on QoS.
The communication process remains seamless from the user's perspective.

### Resource Efficiency:

The method does not require additional power-intensive techniques like artificial noise or jamming.
Perturbations are applied within the normal transmission parameters, conserving resources.

Analysis of secrecy capacity can be as follows. The secrecy capacity Cₛ can be a measure of the maximum transmission rate at which data can be sent securely over a wiretap channel.

Main channel capacity C_{b}, given by:

$${C}_{b} = {log}_{2} ( 1 + \frac{{\vert {h}_{{T}_{x} {R}_{x}} \vert}^{2} P}{{N}_{o}} )$$

where:
P is the transmission power.
Nₒ is the noise power spectral density at Rx.

Eavesdropper channel capacity Cₑ, given by:

$${C}_{e} = {log}_{2} ( 1 + \frac{{\vert {h}_{{T}_{x} Eve} \vert}^{2} P}{{N}_{o , Eve}} )$$

where N_{o,Eve} is the noise power spectral density at Eve.

Impact of perturbations: The perturbations can effectively reduce

$$‖ {h}_{{T}_{x} , Eve}^{′} ‖$$

as perceived by Eve. The eavesdropper's channel becomes:

|h′_{T}_{ₓ}_{Eve}|=|h_{T}_{ₓ}_{Eve}·θ|

Since θ appears random to Eve, |h′_{T}_{ₓ}_{Eve} | can be reduced.

### Enhanced Secrecy Capacity:

With Cₑ reduced, Cₛ increases.
The goal can be to achieve Cₛ>0, ensuring secure communication.

The following is an example scenario in which the present techniques can be implemented. Consider the following parameters:
Transmission power P=Pₘₐₓ
Noise power Nₒ=N_{o,Eve}
Without perturbations:

$${C}_{b} = {log}_{2} ( 1 + \frac{{\vert {h}_{{T}_{x} {R}_{x}} \vert}^{2} P}{{N}_{o}} )$$

$${C}_{e} = {log}_{2} ( 1 + \frac{{\vert {h}_{{T}_{x} Eve} \vert}^{2} P}{{N}_{o , Eve}} )$$

If |h_{T}_{ₓ}_{R}_{ₓ}|≈|h_{T}_{ₓ}_{Eve}|, Cₛ≈0.
By introducing perturbations,

$$\vert {h}_{{T}_{x} Eve}^{′} \vert$$

can be effectively reduced.

$${C}_{e}^{′} = {log}_{2} ( 1 + \frac{{\vert {h}_{{T}_{x} Eve}^{′} \vert}^{2} P}{{N}_{o , Eve}} )$$

$${C}_{s}^{′} = {C}_{b} - {C}_{e}^{′} > 0$$

In some examples of the present techniques, there can be the following implementation considerations.

### Hardware:

The transmitter and receiver can require processing capabilities to perform real-time calculations.
Inclusion of secure storage for keys and synchronization data.

Computational complexity:
The machine learning model can be optimized for real-time execution.
Techniques like model compression or edge computing can be utilized.

Security of synchronization mechanism:
Robust key management practices can be implemented.
Protection against replay attacks, synchronization loss, and other potential vulnerabilities.

Regulatory compliance: Frequency hopping and other perturbations can comply with regulatory standards on spectrum usage.

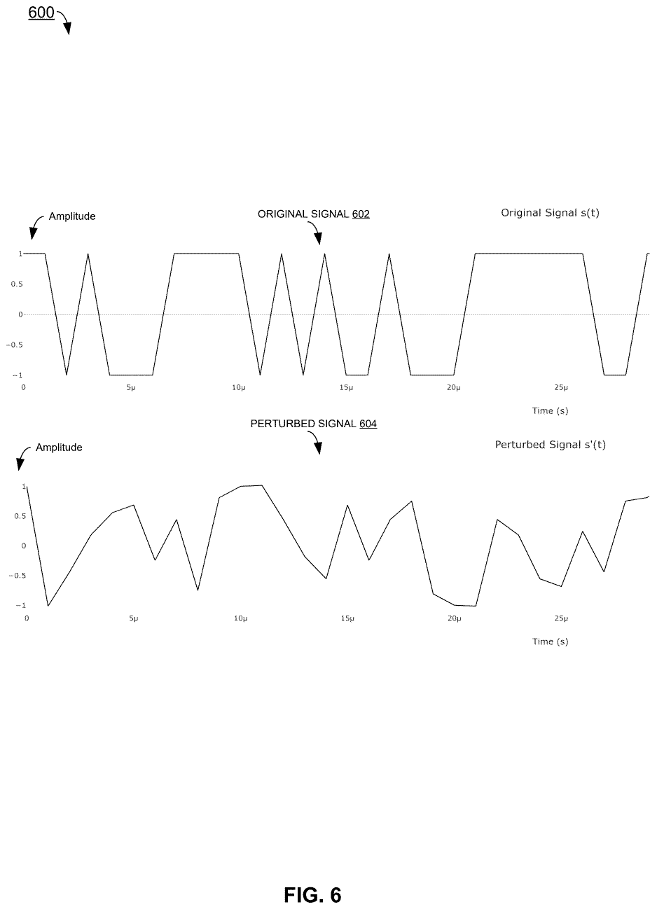

FIG. 6 illustrates an example of waveforms 600 of an original signal and a perturbed signal, and that can facilitate dynamic channel state information manipulation for physical layer security in private wireless networks, in accordance with an embodiment of this disclosure. In some examples, part(s) of waveforms 600 can be used by part(s) of system architecture 100 of FIG. 1 to facilitate dynamic channel state information manipulation for physical layer security in private wireless networks.

Waveforms 600 comprises original signal 602, and perturbed signal 604, where perturbed signal 604 comprises original signal 602 after perturbations have been applied to it, according to the present techniques.

FIG. 7 illustrates an example of waveforms 700 of an original signal, a signal at a legitimate receiver after compensation, and a signal at an eavesdropper, and that can facilitate dynamic channel state information manipulation for physical layer security in private wireless networks, in accordance with an embodiment of this disclosure. In some examples, part(s) of waveforms 700 can be used by part(s) of system architecture 100 of FIG. 1 to facilitate dynamic channel state information manipulation for physical layer security in private wireless networks.

Waveforms 700 comprises original signal 702, signal at a legitimate receiver after compensation 704, and signal at an eavesdropper 706. Signal at a legitimate receiver after compensation 704 comprises a version of original signal 702 as received by a legitimate receiver, and after inverse perturbations are applied. Signal at an eavesdropper 706 comprises a version of original signal 702 as received by an eavesdropper that lacks knowledge of what inverse perturbations to be applied. As such, the legitimate receiver can be more successful in decoding the signal than the eavesdropper is.

### Example Process Flows

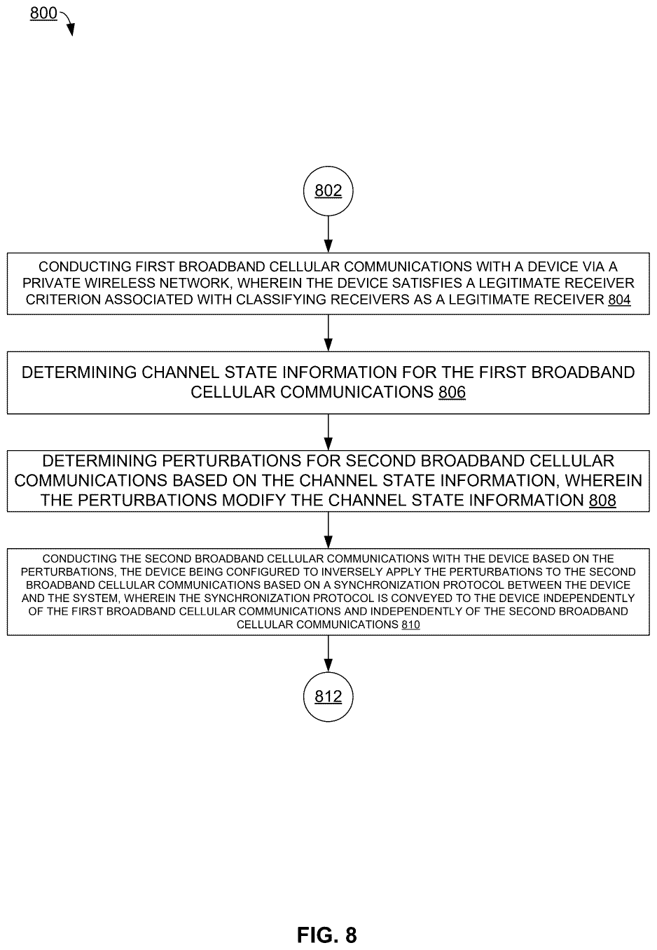

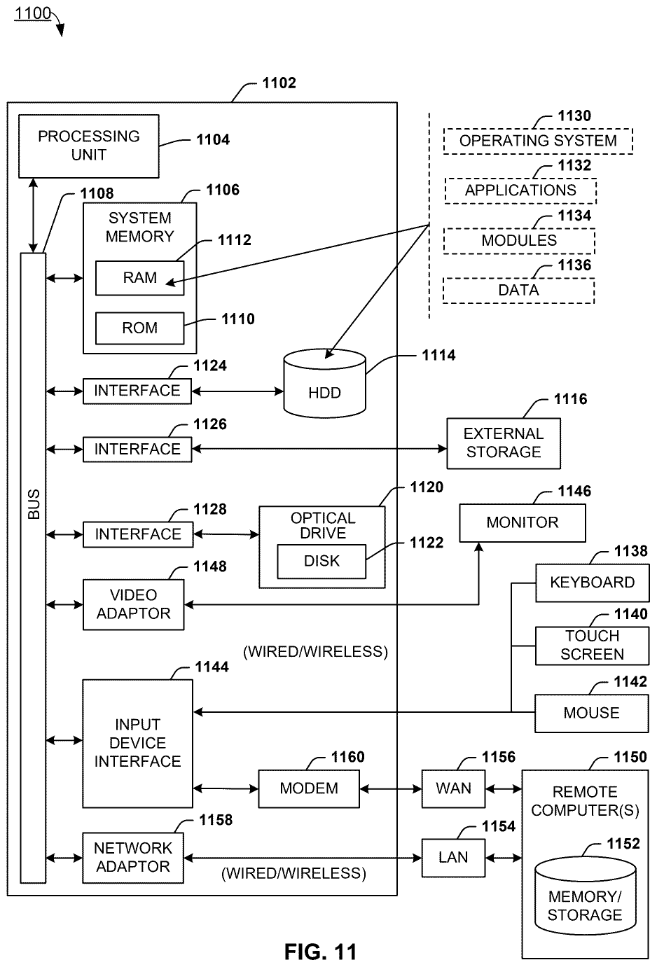

FIG. 8 illustrates an example process flow 800 that can facilitate dynamic channel state information manipulation for physical layer security in private wireless networks, in accordance with an embodiment of this disclosure. In some examples, one or more embodiments of process flow 800 can be implemented by dynamic channel state information manipulation for physical layer security in private wireless networks component 108 of FIG. 1, or computing environment 1100 of FIG. 11.

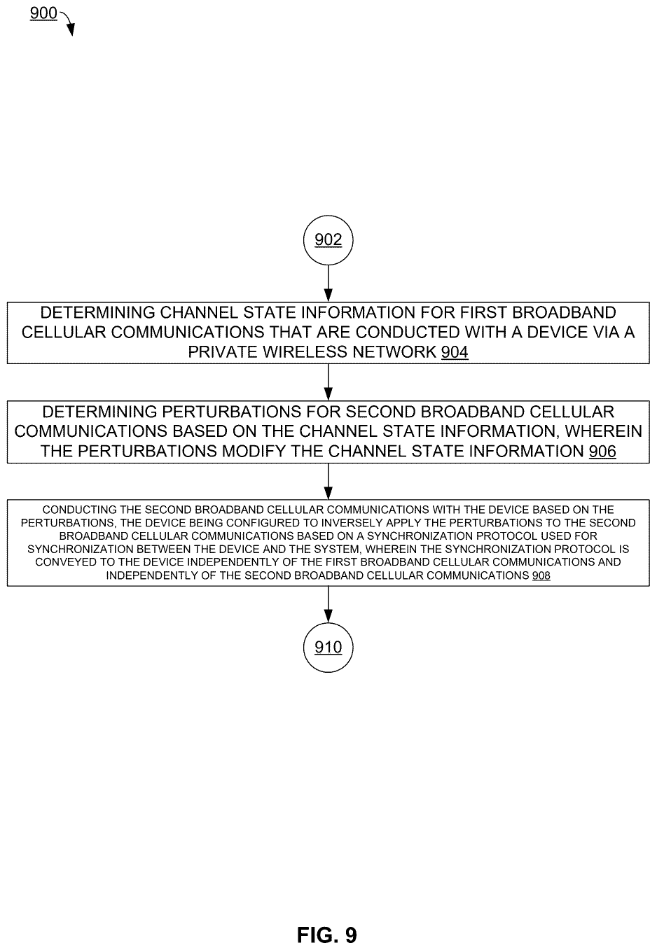

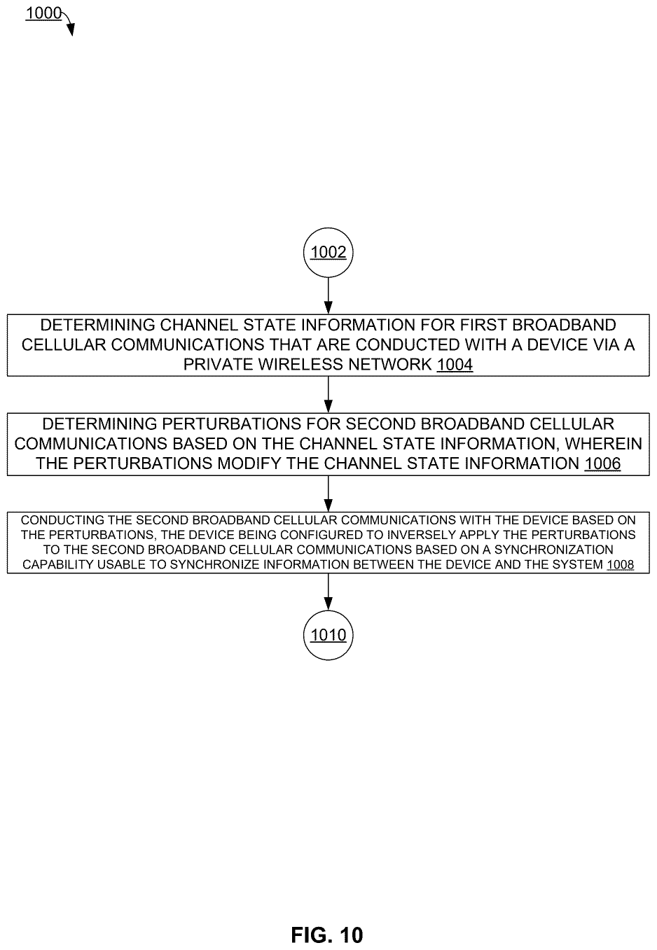

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 900 of FIG. 9, and/or process flow 1000 of FIG. 10.

Process flow 800 begins with 802, and moves to operation 804.

Operation 804 depicts conducting first broadband cellular communications with a device via a private wireless network, wherein the device satisfies a legitimate receiver criterion associated with classifying receivers as a legitimate receiver. Using the example of FIG. 1, base station 102 can be conducting first broadband cellular communications with legitimate receiver device 104, using a private wireless network.

After operation 804, process flow 800 moves to operation 806.

Operation 806 depicts determining channel state information for the first broadband cellular communications. That is, the CSI for the communications between base station 102 of FIG. 1 and legitimate receiver device 104 can be determined.

After operation 806, process flow 800 moves to operation 808.

Operation 808 depicts determining perturbations for second broadband cellular communications based on the channel state information, wherein the perturbations modify the channel state information. That is, perturbations to be added to communications between base station 102 of FIG. 1 and legitimate receiver device 104 can be determined.

After operation 808, process flow 800 moves to operation 810.

Operation 810 depicts conducting the second broadband cellular communications with the device based on the perturbations, the device being configured to inversely apply the perturbations to the second broadband cellular communications based on a synchronization protocol between the device and the system, wherein the synchronization protocol is conveyed to the device independently of the first broadband cellular communications and independently of the second broadband cellular communications. That is, the perturbations can be used to modify signals sent between base station 102 of FIG. 1 and legitimate receiver device 104, where eavesdropper device 106 has difficulty (or is unable) to decode the signal because it is unaware of how to inverse the perturbations (while legitimate receiver device 104 is aware of how to inverse the perturbations).

In some examples, the conducting of the second broadband cellular communications with the device based on the perturbations comprises applying a phase shift to the second broadband cellular communications based on the perturbations.

In some examples, the conducting of the second broadband cellular communications with the device based on the perturbations comprises applying an amplitude adjustment to the second broadband cellular communications based on the perturbations.

In some examples, the conducting of the second broadband cellular communications with the device based on the perturbations comprises modulating a carrier frequency of the second broadband cellular communications based on the perturbations.

That is, perturbations can comprise phase shifts (introducing specific phase alterations to the transmitted signal), amplitude adjustments (varying signal amplitude within permissible limits), and/or frequency variations (modulating the carrier frequency according to predetermined patterns).

In some examples, the synchronization protocol between the device and the system comprises application of a secret to the device and to the system prior to the conducting of the first broadband cellular communications. In some examples, the secret comprises a cryptographic key, or at least one computer executable instruction corresponding to a defined computing process. In some examples, the defined computing process satisfies a time-varying process criterion associated with a time-varying condition exhibited by the defined computing process.

That is, a synchronization mechanism used by a base station and a legitimate receiver can comprise pre-shared secrets (keys or algorithms can be shared during a secure initialization phase) and/or time-varying algorithms (dynamic algorithms can be known only to the transmitter and legitimate receiver).

After operation 810, process flow 800 moves to 812, where process flow 800 ends.

FIG. 9 illustrates an example process flow 900 that can facilitate dynamic channel state information manipulation for physical layer security in private wireless networks, in accordance with an embodiment of this disclosure. In some examples, one or more embodiments of process flow 900 can be implemented by dynamic channel state information manipulation for physical layer security in private wireless networks component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904.

Operation 904 depicts determining channel state information for first broadband cellular communications that are conducted with a device via a private wireless network. In some examples, operation 904 can be implemented in a similar manner as operations 804-806 of FIG. 8.

After operation 904, process flow 900 moves to operation 906.

Operation 906 depicts determining perturbations for second broadband cellular communications based on the channel state information, wherein the perturbations modify the channel state information. In some examples, operation 906 can be implemented in a similar manner as operation 808 of FIG. 8.

In some examples, the determining of the perturbations comprises determining the perturbations based on the channel state information, and based on a security criterion associated with at least a threshold security associated with the second broadband cellular communications.

In some examples, the determining of the perturbations comprises determining the perturbations based on the channel state information, and based on a quality-of-service criterion associated with at least a threshold quality-of-service associated with the second broadband cellular communications. That is, a combination of real-time CSI, and predefined security and QoS standards can be used to determine the perturbations.

In some examples, the determining of the perturbations comprises inputting the channel state information to a machine learning model, wherein the machine learning model outputs the perturbations. In some examples, the machine learning model is trained based on a training dataset indicative of channel communications that satisfy a private wireless network criterion associated with communications via a private wireless network. That is, a trained ML model can take as input a combination of real-time CSI, and predefined security and QoS standards, and produce as output perturbation parameters that are tailored to current network conditions. The ML model can be trained on a dataset that represents a variety of channel conditions, such as those that are specific to PWNs.

In some examples, the training dataset satisfies a defined detected-threat criterion associated with defined events being classified as a detected threat. That is, the ML model can learn from detected threats and/or historical data to security measures for the private wireless network.

After operation 906, process flow 900 moves to operation 908.

Operation 908 depicts conducting the second broadband cellular communications with the device based on the perturbations, the device being configured to inversely apply the perturbations to the second broadband cellular communications based on a synchronization protocol used for synchronization between the device and the system, wherein the synchronization protocol is conveyed to the device independently of the first broadband cellular communications and independently of the second broadband cellular communications. In some examples, operation 908 can be implemented in a similar manner as operation 810 of FIG. 8.

In some examples, operation 908 comprises performing iterations of the determining of the perturbations and the conducting the second broadband cellular communications, based on iterations of the channel state information. That is, part(s) of process flow 900 can be iteratively repeated for real-time channel analysis and adaptation.

After operation 908, process flow 900 moves to 910, where process flow 900 ends.

FIG. 10 illustrates an example process flow 1000 that can facilitate dynamic channel state information manipulation for physical layer security in private wireless networks, in accordance with an embodiment of this disclosure. In some examples, one or more embodiments of process flow 1000 can be implemented by dynamic channel state information manipulation for physical layer security in private wireless networks component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 800 of FIG. 8, and/or process flow 900 of FIG. 9.

Process flow 1000 begins with 1002, and moves to operation 1004.

Operation 1004 depicts determining channel state information for first broadband cellular communications that are conducted with a device via a private wireless network. In some examples, operation 1004 can be implemented in a similar manner as operations 804-806 of FIG. 8.

After operation 1004, process flow 1000 moves to operation 1006.

Operation 1006 depicts determining perturbations for second broadband cellular communications based on the channel state information, wherein the perturbations modify the channel state information. In some examples, operation 1006 can be implemented in a similar manner as operation 808 of FIG. 8.

In some examples, the perturbations affect a physical layer of the second broadband cellular communications. That is, using an Open Systems Interconnection model of networking, the perturbations can be added at the physical layer—e.g., to the radio signal being transmitted (as opposed to a higher layer, such as data link or network).

In some examples, the determining of the perturbations comprises inputting the channel state information to a machine learning model, wherein the machine learning model is trained based on a loss function with a first goal of at least one of increasing or maximizing a secrecy capacity, and with a second goal of at least one of decreasing or minimizing a negative impact on quality of service. That is, a loss function (such as one used by a ML model) can aim to maximize the secrecy capacity Cs while minimizing the impact on QoS.

In some examples, the loss function comprises a power constraint for transmitting broadband cellular communications. That is, there can be a limit of how much power the base station is to use (which can affect, e.g., a perturbation that would increase an amplitude or a frequency of a transmitted signal).

After operation 1006, process flow 1000 moves to operation 1008.

Operation 1008 depicts conducting the second broadband cellular communications with the device based on the perturbations, the device being configured to inversely apply the perturbations to the second broadband cellular communications based on a synchronization capability usable to synchronize information between the device and the system. In some examples, operation 1008 can be implemented in a similar manner as operation 810 of FIG. 8.

In some examples, the device is a first device, the first device satisfies a legitimate receiver criterion associated with classifying receivers as a legitimate receiver, a second device lacks the synchronization capability, and the second device fails to satisfy the legitimate receiver criterion. That is, the first device can be a legitimate receiver, the second device can be an eavesdropper, and the present techniques of applying perturbations can make it difficult for potential eavesdroppers to succeed in eavesdropper, such as because they lack synchronization information possessed by the base station and the legitimate receiver.

In some examples, the synchronization capability usable to synchronize information between the device and the system is effectuated using a key exchange protocol, or a secret key generated based on channel reciprocity. That is, there can be a secure initialization of the synchronization capability. For instance, during a secure setup phase, Tx and Rx can share secret keys or initialize a secure algorithm. In another example, this can involve key exchange protocols or physical layer security approaches like secret key generation from channel reciprocity.

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102, legitimate receiver device 104, and/or eavesdropper device 106.

In some examples, computing environment 1100 can implement one or more embodiments of the process flows of FIGS. 7-10 to facilitate dynamic channel state information manipulation for physical layer security in private wireless networks.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
conducting first broadband cellular communications with a device via a private wireless network, wherein the device satisfies a legitimate receiver criterion associated with classifying receivers as a legitimate receiver;
determining channel state information for the first broadband cellular communications;
determining perturbations for second broadband cellular communications based on the channel state information, wherein the perturbations modify the channel state information; and
conducting the second broadband cellular communications with the device based on the perturbations, the device being configured to inversely apply the perturbations to the second broadband cellular communications based on a synchronization protocol between the device and the system, wherein the synchronization protocol is conveyed to the device independently of the first broadband cellular communications and independently of the second broadband cellular communications.

2. The system of claim 1, wherein the conducting of the second broadband cellular communications with the device based on the perturbations comprises:
applying a phase shift to the second broadband cellular communications based on the perturbations.

3. The system of claim 1, wherein the conducting of the second broadband cellular communications with the device based on the perturbations comprises:
applying an amplitude adjustment to the second broadband cellular communications based on the perturbations.

4. The system of claim 1, wherein the conducting of the second broadband cellular communications with the device based on the perturbations comprises:
modulating a carrier frequency of the second broadband cellular communications based on the perturbations.

5. The system of claim 1, wherein the synchronization protocol between the device and the system comprises application of a secret to the device and to the system prior to the conducting of the first broadband cellular communications.

6. The system of claim 5, wherein the secret comprises a cryptographic key, or at least one computer executable instruction corresponding to a defined computing process.

7. The system of claim 6, wherein the defined computing process satisfies a time-varying process criterion associated with a time-varying condition exhibited by the defined computing process.

8. A method, comprising:
determining, by a system comprising at least one processor, channel state information for first broadband cellular communications that are conducted with a device via a private wireless network;
determining, by the system, perturbations for second broadband cellular communications based on the channel state information, wherein the perturbations modify the channel state information; and
conducting, by the system, the second broadband cellular communications with the device based on the perturbations, the device being configured to inversely apply the perturbations to the second broadband cellular communications based on a synchronization protocol used for synchronization between the device and the system, wherein the synchronization protocol is conveyed to the device independently of the first broadband cellular communications and independently of the second broadband cellular communications.

9. The method of claim 8, wherein the determining of the perturbations comprises:
determining the perturbations based on the channel state information, and based on a security criterion associated with at least a threshold security associated with the second broadband cellular communications.

10. The method of claim 8, wherein the determining of the perturbations comprises:
determining the perturbations based on the channel state information, and based on a quality-of-service criterion associated with at least a threshold quality-of-service associated with the second broadband cellular communications.

11. The method of claim 8, wherein the determining of the perturbations comprises:
inputting the channel state information to a machine learning model, wherein the machine learning model outputs the perturbations.

12. The method of claim 11, wherein the machine learning model is trained based on a training dataset indicative of channel communications that satisfy a private wireless network criterion associated with communications via a private wireless network.

13. The method of claim 12, wherein the training dataset satisfies a defined detected-threat criterion associated with defined events being classified as a detected threat.

14. The method of claim 8, further comprising:
performing, by the system, iterations of the determining of the perturbations and the conducting the second broadband cellular communications, based on iterations of the channel state information.

15. A non-transitory computer-readable medium comprising instructions that, in response to execution, cause a system comprising at least one processor to perform operations, comprising:
determining channel state information for first broadband cellular communications that are conducted with a device via a private wireless network;
determining perturbations for second broadband cellular communications based on the channel state information, wherein the perturbations modify the channel state information; and
conducting the second broadband cellular communications with the device based on the perturbations, the device being configured to inversely apply the perturbations to the second broadband cellular communications based on a synchronization capability usable to synchronize information between the device and the system.

16. The non-transitory computer-readable medium of claim 15, wherein the perturbations affect a physical layer of the second broadband cellular communications.

17. The non-transitory computer-readable medium of claim 15, wherein the device is a first device, wherein the first device satisfies a legitimate receiver criterion associated with classifying receivers as a legitimate receiver, wherein a second device lacks the synchronization capability, and wherein the second device fails to satisfy the legitimate receiver criterion.

18. The non-transitory computer-readable medium of claim 15, wherein the determining of the perturbations comprises:
inputting the channel state information to a machine learning model, wherein the machine learning model is trained based on a loss function with a first goal of at least one of increasing or maximizing a secrecy capacity, and with a second goal of at least one of decreasing or minimizing a negative impact on quality of service.

19. The non-transitory computer-readable medium of claim 18, wherein the loss function comprises a power constraint for transmitting broadband cellular communications.

20. The non-transitory computer-readable medium of claim 15, wherein the synchronization capability usable to synchronize information between the device and the system is effectuated using a key exchange protocol, or a secret key generated based on channel reciprocity.
